(19) United States
(12) Patent Application Publication
(10) Pub. No.: US 2010/0165361 A1
(43) Pub. Date: Jul. 1, 2010

(54) Method for Reducing Consumables Usage Based on Job Size

(76) Inventors: James Ronald Booth, Nicholasville, KY (US); William Paul Cook, Lexington, KY (US); Samuel Leo Rhodus, Lexington, KY (US); Kevin Dean Schoedinger, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/344,998

(22) Filed: Dec. 29, 2008

(51) Int. Cl. G06K 15/02

(52) U.S. Cl. 358/1.2

(57) ABSTRACT

A method implemented by a processor of a printer for reducing consumables usage based on job size includes entering different settings for an n-up printing mode in the printer based on job size such that a job size of one page will be printed 1-up, or on a full page, by the printer, a job size of two and three pages will be printed 2-up, or on a half page, by the printer, and a job size of four pages will printed 4-up, or on a quarter page, by the printer and/or entering a threshold setting for a duplex printing mode in the printer based on job size such that a job size below the threshold will be printed in a simplex mode whereas job size at or above the threshold will be printed in a duplex mode. The method also includes enabling user selection of n-up setting or threshold setting for jobs of predetermined size.

### CROSS REFERENCES TO RELATED APPLICATIONS

None.

### BACKGROUND

1. Field of the Invention

The present invention relates generally to conservation of printer paper and, more particularly, to a method implemented in a printer for reducing consumables usage, such as paper, toner and energy, based on job size.

2. Description of the Related Art

In today's environment, paper usage is the most costly form of printing. A recent life cycle analysis study has found that the manufacturing of paper far out weighed the other costs associated with printing. Settings that inherently conserve paper and reduce consumption are known as “n-up” that places “n” images on one side of a sheet and “duplex” that places images on both sides of a sheet.

To impose paper conservation measures, n-up and duplex settings are often fixed on a printing device and thus applied to entire print jobs of all users. This can be frustrating for users that send only one, or a few, page job to a printing device that has 2-up selected and find their image is scaled down and printed on only one-half of the sheet. Likewise, this can be frustrating for users who may want to simplex small jobs, that is, print on one side only, but the printing device has duplex enabled globally. Still, many users are looking for ways to reduce costs and to be more environmentally friendly.

Thus, there is a need for an innovation that will help lessen conflict between reduction of user frustration and conservation of paper usage by making a reasonable tradeoff in the case of jobs of different sizes by treating small job sizes differently from large job sizes.

### SUMMARY OF THE INVENTION

The present invention meets this need by providing an innovation that will reduce the number of sheets (and correspondingly images) needed for a print job based on job size by treating small job sizes one way and large job sizes another way. More sheet usage in terms of images per sheet is permitted in the case of small job sizes than large job sizes. Furthermore, reducing the size of an image on a sheet also correspondingly reduces the amount of toner consumed and also extends the life of other consumable components used in forming images and another consumable in the form of electrical energy.

Accordingly, in an aspect of the present invention, a method implemented by a processor of a printer for reducing consumables usage based on job size includes entering different settings for an n-up printing mode in the printer based on job size, and/or entering a threshold setting for duplex printing mode in the printer based on job size. Also, the method may include enabling user selection of n-up setting or threshold setting for jobs of predetermined size. The settings can be made accessible to users such that they can be changed by users or the settings be electronically established inside the printer where they are not accessible by users.

In another aspect of the present invention, a method implemented by a processor of a printer for reducing consumables usage based on job size includes entering different settings for an n-up printing mode in the printer based on job size such that a job size of one page will be printed 1-up, or on a full page, by the printer, a job size of two and three pages will be printed 2-up, or on a half page, by the printer, and a job size of four pages will be printed 4-up or, on a quarter page, by the printer, and/or entering a threshold setting for a duplex printing mode in the printer based on job size such that a job size below the threshold will be printed in a simplex mode whereas job size at or above the threshold will be printed in a duplex mode. The method also includes enabling user selection of n-up setting or threshold setting for jobs of predetermined size.

### BRIEF DESCRIPTION OF THE DRAWINGS

Having thus described the invention in general terms, reference will now be made to the accompanying drawings, which are not necessarily drawn to scale and in some instances portions may be exaggerated in order to emphasize features of the invention, and wherein:

FIG. 1 is a schematic representation of a prior art image forming device that may be operated to perform a method for reducing consumables usage based on job size in accordance with the present invention.

FIG. 2 is a flow diagram of a menu incorporated by the image forming device of FIG. 1 for performing the method of the present invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

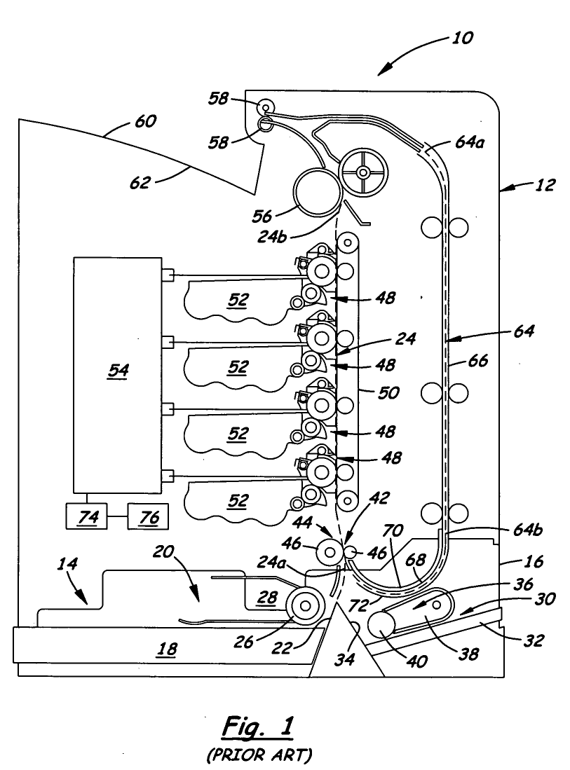

Referring now to FIG. 1, there is illustrated a schematic representation of a prior art image forming device, generally designated 10, such as a laser printer, which may be operated to perform a method for reducing consumables (paper, toner, energy, etc.) usage based on job size in accordance with the present invention. The printer 10 is described in detail in either one of U.S. Pat. Nos. 7,130,574 and 7,136,089 all of which are assigned to the assignee of the present invention. Their disclosures are hereby incorporated by reference.

As seen in FIG. 1, the printer 10 includes a housing 12 and a media input tray 14 removably disposed in the housing 12 through a lower front opening 16 in the housing 12 and providing a source of media sheets for the operations of the printer 10. The input tray 14 is sized to hold a first stack 18 of the media sheets. A sheet pick mechanism 20 also disposed in the housing 12 feeds or picks the media sheets from the tray 14 and along a ramp 22 that directs the sheets further along toward an entrance end 24a of an image formation path 24. The sheet pick mechanism 20 may include a roller 26 positioned on a pivoting arm 28. The pivoting arm 28 causes the roller 26 to remain in contact with a topmost sheet on the first stack 18. Rotation of the roller 26 removes the media sheet from the stack 18 with the leading edge contacting the ramp 22 so that the sheet will thus be moved toward the entrance end 24a of the image formation path 24.

A multi-purpose feeder 30 may also be included in the housing 12 of the printer 10 to move additional media sheets toward the entrance end 24a of the image formation path 24. The multi-purpose feeder 30 includes a support floor 32 adjacent to another ramp 34. An additional sheet pick mechanism 36 is provided, having a pivoting arm 38 and a roller 40 thereon. Rotation of the roller 40 moves the media sheet from the support floor 32 up the ramp 34 toward the entrance end 24a of the image formation path 24. The additional sheet pick mechanism 36 within the multi-purpose feeder 30 may be the same or different from the sheet pick mechanism 20 associated with the media input tray 14.

The operation of the printer 10 is conventionally well-known. After a media sheet is introduced through the input tray 14 or a multi-purpose feeder 30, the media sheet is presented at the entrance end 24a of the image formation path 24 as defined by a nip 42 of a media alignment mechanism 44 formed between its pair of rollers 46. The media alignment mechanism 44 removes lateral skew from the media sheet and precisely times its passage on to the image forming stations 48 located downstream along the image formation path 24.

After the media sheet passes the media alignment mechanism 44 it contacts a transport belt 50, which carries the media sheet along the image formation path 24 past successive photoconductor units 52 of the image forming stations 48. At each successive photoconductor unit 52, a latent image is formed by an imaging device 54 and optically projected onto a photoconductive member. The latent image is developed by applying toner to the photoconductive member from a toner reservoir. The toner is subsequently deposited on the media sheet as it is conveyed past each of the photoconductor units 52 by the transport belt 50.

The toner is then thermally fused to the media sheet by a fuser 56 and the sheet then passes through an exit end 24b of the image formation path 24 to a media sheet directing mechanism in the form of a pair of reversible exit rollers 58 which feed the media sheet face down onto a media sheets collection site 60 on a top exterior portion 62 of the printer housing 12. Alternatively, the exit rollers 58 may reverse motion after the trailing edge of the media sheet has passed an inlet end 64a to a duplex path 64. The reversed exit rollers 58 then direct the media sheet through the inlet end 64a of the vertically-oriented duplex path 64 to where the media sheet moves through an internal structure 66 defining the duplex path 64 to an outlet end 64b of the duplex path 64 from which the media sheet then travels through a return path 68 defined between a pair of upper and lower guides 70, 72 that interconnect the outlet end 64b of the duplex path 64 with the nip 42 at the entrance end 24a of the image formation path. Then the media sheet is transported back through the image formation path 24 where it is processed for the printing of another image on the back side of the media sheet. The doubled-sided printed media sheet is then delivered face down to the collection site 60 on the printer housing 12.

The printer 10 also includes a processor 74 and a memory 76. The processor 74 is connected to the imaging device 54 for controlling transferring of a toner image onto the media sheet, as well as movement of the media sheet through the image formation path 24 and duplex path 64. The processor 74 includes logic circuitry to control the operation of the printer 10 through the imaging device 54 and other drivers (not shown) according to program instructions stored in the memory 76. The processor 74 may be, for example, one or more microcontrollers or microprocessors. The processor 74 may be incorporated within a custom integrated circuit or application specific integrated circuit (ASIC). The memory 76 may be incorporated into the processor 74, or may comprise a discrete memory device, such as random access memory (RAM), read only memory (ROM), electrically erasable programmable read only member (EEPROM), and FLASH memory. The memory 76 may be part of the same ASIC as the processor 74. As briefly described above, the printer 10 may operate in simplex or duplex mode. In simplex mode, toner images are transferred to one side of the media sheet. In duplex mode, after an image is applied to one side of the media sheet, the media sheet is partially ejected from the printer 10 and then fed into the duplex path 64. The inverted media sheet is then fed back to the primary image formation path 24 and a second image is transferred to the other side of the media sheet.

In accordance with the present invention, a method is employed by the printer 10 for reducing paper usage based on job size, that is, on actual job page count. The method involves entering into appropriate software in memory 76 settings for operation of an n-up printing mode in the printer 10 based on job size and/or entering a threshold setting for operation of a duplex printing mode in the printer 10 also based on job size. For example, the settings for operation of the n-up printing mode provide that: a job size (page count) of one page will be printed 1-up, or on a full page, by the printer 10; a job size of two and three pages will be printed 2-up, or on a half page, by the printer 10; and a job size of four pages will printed 4-up, or on a quarter page, by the printer 10. The setting for operation of the duplex printing mode provides that a job size (page count) below the threshold will be printed in a simplex mode, whereas a job size at or above the threshold will be printed in a duplex mode. Entering the settings can be made accessible to users such that they can be changed by users; or the settings can be protected such that they are only electronically established inside the printer where they are not accessible by users.

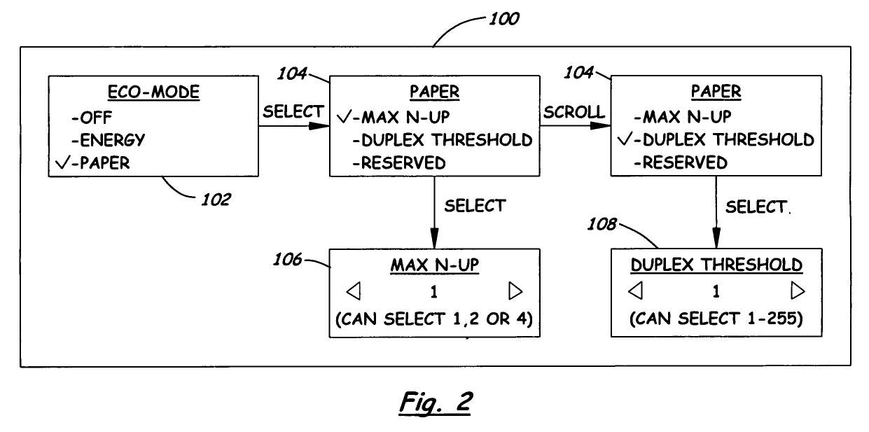

Referring now to FIG. 2, there is shown a flow diagram of an exemplary embodiment of a menu 100, in this instance an Eco-mode menu. The blocks 102-108 of the diagram show the possible selections that a user makes that provide inputs to software stored in the memory 76 of the printer 10 of FIG. 1 to initiate the processor 74 in controlling printing operations in a manner which reduces consumables, such as paper and toner, usage. The menu 100 enables the user to be able to select an n-up setting and/or duplex threshold setting for jobs of predetermined size. Referring to block 102, the user first chooses between an “off” condition, an “energy” saver mode, or “paper” mode, which means steps for initializing a printing operation. The user scrolls between these choices by moving the check mark and then clicking on the block 102 to selected the checked one of the choices.

When the “paper” mode is selected at block 102, the flow of the menu 100 is next to block 104. At block 104, the user chooses between a Max N-up printing mode or Duplex Threshold printing mode. This is accomplished by the user scrolling the check mark to select one of the choices and then clicking on the block 104. If the Max N-up is selected at block 104, then the flow of the menu 100 is to block 106 where the user can select between numbers 1, 2 or 4 to determine the number of images to be printed on one side of the sheet. If the Duplex Threshold is selected at block 104, then the flow of the menu 100 is to block 108 where the user can select between numbers 1-255 to determine the duplex threshold where two-sided printing of images on sheets will take place or, in other words, under which one-sided printing of images on sheets will take place.

In view of the above description, one way to reduce the number of printed pages based on the actual job page count is the Max “n-up’ printing mode selection. It is a ‘n-up’ solution that maximizes the available print area by selecting the appropriate n-up mode based on the job size and dynamically scaling the image accordingly. For example, 1 page jobs would print 1-up (full size), 2-3 page jobs would print 2-up, and 4+ page jobs would print 4-up. The maximum n-up could be programmed by the user or IT administrator. Another way to reduce the number of printed pages based on the actual job page count is the Duplex Threshold printing mode selection. It is a duplex solution that enforces duplex printing when the job size is above a predefined threshold. For example, if the threshold was set at 10 pages, then a 5-page job would be printed in simplex, but a 15-page job would be printed in duplex. A count of 1 would be the equivalent of a duplex “on” setting. The maximum duplex threshold could be programmed by the user or IT administrator. The two ways just described can also be combined since they work independent of one another. These settings would be accessed from a web page or other host based utilities. An alternative method would be to implement this function within the printer driver, making the function more visible and understandable to the user.

As an extra benefit, the N-up setting automatically reduces the toner consumption by a similar amount. That is, a job printed 2-up would use about half of the toner and PCU life, and a 4-up job would consume about one-fourth of the supplies compared to the normal job. The reduction would have little or no impact on the normal job overhead during run-in and run-out. The job throughput would also increase by the N-up setting as the page count is reduced. The paper usage reduction based on job length could be extended to other consumable controls, such as toner darkness. The darkness can be reduced automatically for long jobs, but left at a normal setting for short jobs, with the threshold selected by the user.

It should be understood that the term “printer” as used herein is intended to have a generic meaning that includes any image forming device that has its processor or any device where the processor is in a host separate from the device.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A method for reducing consumables usage based on job size, comprising:
entering different settings in a printer for n-up printing mode in the printer based on job size; or
entering a threshold setting in a printer for duplex printing mode in the printer based on job size.

2. The method of claim 1 further comprising;
enabling user selection of n-up setting or threshold setting for jobs of predetermined size.

3. The method of claim 1 wherein said entering different settings is performed by installing a driver in the printer that prescribes said settings.

4. The method of claim 1 wherein said entering different settings includes entering a setting of 1-up based on a job size of one page.

5. The method of claim 1 wherein said entering different settings includes entering a setting of 2-up based on a job size of two or three pages.

6. The method of claim 1 wherein said entering different settings includes entering a setting of 4-up based on a job size of four pages.

7. The method of claim 1 wherein said entering different settings includes entering a setting of 1-up based on a job size of one page and entering a setting of 2-up based on a job size of two or three pages.

8. The method of claim 7 wherein said entering different settings includes entering a setting of 4-up based on a job size of four pages.

9. The method of claim 1 wherein said entering said different n-up settings is carried out by a user entering said settings into the printer.

10. The method of claim 1 wherein said entering said threshold setting is carried out by a user entering said setting into the printer.

11. A method implemented by a processor of a printer for reducing consumables usage based on job size, comprising:
entering different settings for n-up printing mode in the printer based on job size;
entering a threshold setting for duplex printing mode in the printer based on job size; and
enabling user selection of n-up setting and threshold setting for jobs of predetermined size.

12. The method of claim 11 wherein said implementing includes accessing said different settings via an input terminal for changing said settings.

13. The method of claim 11 wherein said entering includes installing a driver in the printer that prescribes said settings.

14. The method of claim 11, wherein said entering different settings includes entering a setting of 1-up based on a job size of one page.

15. The method of claim 11 wherein said entering different settings includes entering a setting of 2-up based on a job size of two or three pages.

16. The method of claim 11 wherein said entering different settings includes entering a setting of 4-up based on a job size of four pages.

17. The method of claim 11, wherein said entering different settings includes entering a setting of 1-up based on a job size of one page and entering a setting of 2-up based on a job size of two and three pages.

18. The method of claim 17 wherein said entering different settings includes entering a setting of 4-up based on a job size of four pages.

19. The method of claim 11, wherein said entering different n-up settings and said threshold setting is carried out by a user entering said settings into the printer.

20. A method implemented by a processor of a printer for reducing consumables usage based on job size, comprising:
entering different settings for a n-up printing mode in the printer based on job size such that a job size of one page will be printed 1-up, or on a full page, by the printer, a job size of two and three pages will be printed 2-up, or on a half page, by the printer, and a job size of four pages will printed 4-up, or on a quarter page, by the printer;
entering a threshold setting for a duplex printing mode in the printer based on job size such that a job size below the threshold will be printed in a simplex mode whereas job size at or above the threshold will be printed in a duplex mode; and
enabling user selection of n-up setting and threshold setting for jobs of predetermined size.
